(19) United States
(12) Patent Application Publication
(10) Pub. No.: US 2010/0296813 A1
(43) Pub. Date: Nov. 25, 2010

(54) OPTICAL SIGNAL PROCESSING METHOD AND DEVICE AND ASSOCIATED CENTRAL EQUIPMENT AND ACCESS NETWORK

(75) Inventors: Philippe Chanclou, Lannion (FR); Julien Poirrier, Locquemeau (FR); Franck Payoux, Bagneux (FR)

Correspondence Address: WESTMAN CHAMPLIN & KELLY, P.A., SUITE 1400, 900 SECOND AVENUE SOUTH, MINNEAPOLIS, MN, 55402, US

(73) Assignee: FRANCE TELECOM, Paris (FR)

(21) Appl. No.: 12/520,818

(22) PCT Filed: Dec. 14, 2007
(86) PCT No.: PCT/FR2007/052512

§ 371 Date: Jun. 22, 2009

(30) Foreign Application Priority Data
Dec. 22, 2006 (FR) 0655851

(51) Int. Cl. H04J 14/08

(52) U.S. Cl. 398/98

(57) ABSTRACT

A method and apparatus are provided for processing a composite optical signal formed of a sequence of time sectors obtained by time-division multiplexing a plurality of optical signals transmitted on a plurality of transmission channels of a shared optical access network. The method includes: taking account of a schedule for transmission of the plurality of optical signals in the access network, the schedule associating with a time sector an optical signal of the sequence and a transmission channel of the plurality of transmission channels used by the optical signal; recovering a set of representative performance parameters of the transmission channel associated with the time sector; and adaptively correcting the time sector using the set of parameters.

### CROSS-REFERENCE TO RELATED APPLICATIONS

This Application is a Section 371 National Stage Application of International Application No. PCT/FR2007/052512, filed Dec. 14, 2007 and published as WO 2008/081140 on Jul. 10, 2008, not in English.

### STATEMENT REGARDING FEDERALLY SPONSORED RESEARCH OR DEVELOPMENT

None.

### THE NAMES OF PARTIES TO A JOINT RESEARCH AGREEMENT None.

### FIELD OF THE DISCLOSURE

The present disclosure relates generally to telecommunications and more particularly to optical telecommunications.

The disclosure finds its application in optical access networks and more particularly in shared access networks using time-division multiplexing (TDM) to exchange information between terminal equipments and a central equipment situated at a node of the access network.

### BACKGROUND OF THE DISCLOSURE

TDM is currently the most widely used multiplexing solution in 1-to-N shared passive optical fiber access networks in which a central equipment communicates with N terminal equipments. The time-division multiplexing is performed by a coupler of characteristics and integration that cause no design problems at present.

In such an access network, data is transmitted bidirectionally. Simultaneous downlink and uplink transmission is made possible by wavelength-division multiplexing in the downlink direction (at 1.49 micrometers (μm)) and in the uplink direction (at 1.31 μm).

When data is transmitted in the downlink direction, i.e. from the central equipment to a plurality of terminal equipments, the signal used consists of N contiguous time slots each containing data for one of the N terminal equipments. This signal is a time-division multiplex. The signals also include management time slots common to all the terminal equipments. These management time slots, contain data management and configuration information. A device such as a coupler located at an access node broadcasts the signal to each of the N destination terminal equipments so that each of them can receive the signal portion that relates to it.

When data is transmitted in the uplink direction, i.e. from the terminal equipments to the central equipment, the signal received by the access node is also divided into time slots each corresponding to the transmission from one of the N terminal equipments. This signal is an optical time-division multiplex of the optical signals transmitted individually by each terminal equipment. In order to be able to produce this composite optical signal, it is necessary for each terminal equipment to transmit its optical signal at the same bit rate as the other terminal equipments. In order to avoid loss of the data transported when creating the composite signal, it is also important that the time slots do not overlap.

There have been two trends in the evolution of optical access network transmission systems:
increasing optical access network bit rates, typically to reach 10 gigabits per second (Gbit/s);
increasing the range beyond 20 kilometers (km).

Such evolution imposes penalties on transmission of the optical signal, making it necessary to process the transmitted optical signal in order to compensate the penalties introduced on transmission.

Known optical signal processing techniques correct such penalties introduced on transmitting an optical signal on a point-to-point connection. A device using such techniques “learns” characteristic performance parameters of the transmission channel from optical signals previously transmitted. Such a device is not suitable for a time-division multiplex optical signal transmitted on a 1-to-N connection. A time-division multiplex optical signal is formed of a sequence of time sectors routed via different transmission channels. The characteristic performance parameters of the transmission channel are thus liable to change for each time sector. According to the document “Adaptive PMD compensation by optical and electrical techniques” by Buchali and Büllow, published in “Journal of Lightwave Technology”, Volume 22, Issue 4, April 2004, it is difficult for such devices to adapt in less than one millisecond. Consequently, the above device does not have time between first and second time sectors to learn the characteristic performance parameters of the second time sector.

### SUMMARY

An aspect of the present disclosure relates to a method of processing a composite optical signal formed of a sequence of time sectors obtained by time-division multiplexing a plurality of optical signals transmitted on a plurality of transmission channels of a shared optical access network.

Said processing method includes the following steps:
taking account of a schedule for transmission of said plurality of optical signals in said access network, said schedule associating with a time sector an optical signal and a communications channel used by said optical signal;
recovering a set of representative performance parameters of said transmission channel associated with said time sector; and
adaptively correcting the time sector using the set of parameters.

Thus an embodiment of the invention is based on an entirely novel and inventive approach to adaptive processing of composite optical signals formed by time-division multiplexing a plurality of optical signals conveyed by a passive optical access network. An embodiment of the invention proposes to use the schedule for transmitting said plurality of optical signals to access the representative performance parameters of the transmission channel employed by each time sector of the composite optical signal concerned and to deduce therefrom an appropriate correction for each time sector.

Thus an embodiment of the invention solves the technical problem of adapting a signal processing function to rapid changes in a composite signal of a sequence of time sectors transmitted on a plurality of different transmission channels.

The transmission schedule matches a time sector to the optical signal from which it comes and the transmission channel that is carrying it. The expression “transmission channel” as used here refers generically to the path formed of a transmission channel or a succession of transmission channels that the time sector follows from its source to its destination.

According to one aspect of the invention, the processing method further includes a step of computing a set of correction parameter values from said set of representative performance parameters of said channel.

Such a set of parameters characterizes the transmission channel used by the time sector concerned, enables appropriate processing parameters to be deduced therefrom, and applies to the time sector processing based on those parameters.

According to another aspect of the invention, said adaptive correction step uses a set of average values of processing parameters computed for the plurality of optical signals. In other words, the same set of processing parameters is computed for all the time sectors of the composite optical signal. This set of processing parameters takes account of the sets of values of representative performance parameters of the plurality of transmission channels. This solution has the advantages of simplicity and low consumption of resources. The single set of transmission parameter values is stored in memory.

The set of processing parameter values computed is advantageously specific to an optical signal. This means that the time sectors corresponding to the same optical signal are associated with a set of specifically calculated parameter values. An advantage of this solution is its precision. Specific processing is applied to each time sector of the composite optical signal.

According to another aspect of the invention, the values of said representative performance parameters of said plurality of transmission channels are computed by means of a training process.

According to another aspect of the invention, said training process is performed on the initialization of the plurality of transmission channels. One advantage of this embodiment is its simplicity.

Said training process is preferably repeated during the functioning of the transmission channel. An advantage of this is that the method of this aspect of the invention regularly adjusts the values of the parameters used.

According to one aspect of the invention, the adaptive correction step corrects the composite optical signal in the optical domain. The advantages of an optical solution are improved performance and reduced electrical power consumption.

According to another aspect of the invention, the processing method includes, before the adaptive correction step, a step of converting the composite optical signal into a composite electrical signal and the adaptive correction step corrects the composite electrical signal in the electrical domain.

The advantages of an electrical solution are its low cost, its simplicity, and its processing speed.

The electrical processing can be performed on transmitting the signal and/or on receiving it:
when the processing is performed on transmission, it consists of pre-compensation and, after the adaptive correction step, there is a step of converting the corrected composite signal into a composite optical signal;
when the processing is performed on reception, it consists of post-compensation and, before the adaptive correction step, there is a step of converting the composite optical signal into a composite electrical signal.

An embodiment of the invention also relates to a device for processing a composite optical signal formed of a sequence of time sectors obtained by time-division multiplexing a plurality of optical signals transmitted on a plurality of transmission channels of a shared optical access network.

The device is special in that it includes:
means for taking account of a schedule for transmission of said plurality of optical signals in said access network, said schedule associating with a time sector an optical signal and a communications channel used by said optical signal;
means for recovering a set of representative performance parameters of said transmission channel associated with said time sector; and
means for adaptively correcting the time sector using the set of parameters.

A further embodiment of the invention relates to a central equipment of a optical access network shared between a plurality of terminal equipments able to transmit a first composite optical signal formed of a sequence of time sectors obtained by time-division multiplexing a plurality of optical signals going to said plurality of terminal equipments.

Such a central equipment is special in that it includes a first device of an embodiment of the invention for processing the first composite signal.

According to another aspect of the invention, said central equipment is able to receive a second composite signal formed of a sequence of time sectors obtained by time-division multiplexing a second plurality of optical signals coming from said plurality of terminal equipments and includes a second device of an embodiment of the invention for processing the second composite signal.

A further embodiment of the invention relates to an optical access network shared by a plurality of terminal equipments connected to a central equipment by a plurality of transmission channels, said central equipment being adapted to transmit a first composite signal formed of a sequence of time sectors obtained by time-division multiplexing a first plurality of optical signals going to said plurality of terminal equipments. Such an access network is special in that said central equipment includes a first device of an embodiment of the invention for correcting said first composite signal.

Such an access network processes the optical signals transmitted in the downlink direction in an adaptive fashion.

According to one aspect of the invention, said central equipment is able to receive a second composite optical signal formed of a sequence of time sectors obtained by time-division multiplexing a second plurality of optical signals coming from said plurality of terminal equipments. Said central equipment is special in that it includes a second device of an embodiment of the invention for correcting said second composite signal.

Such an access network also processes the optical signals transmitted in the uplink direction in an adaptive fashion.

A further embodiment of the invention relates finally to a computer program product downloadable from a communications network and/or stored on a computer-readable medium and/or executable by a microprocessor. Such a computer program is characterized in that it includes program code instructions for executing the method of an embodiment of the invention for processing a plurality of optical signals transmitted over an optical access network when it is executed on a computer.

### BRIEF DESCRIPTION OF THE DRAWINGS

Other advantages and features become more clearly apparent on reading the following description of one particular embodiment of the invention, which is given by way of illustrative and non-limiting example only, and from the appended drawings, in which:

FIG. 1 shows an example of a prior art access network in the form of a passive optical network (PON) connecting a central equipment and a plurality of terminal equipments in a downlink direction;

FIG. 2 shows an example of a prior art access network in the form of a passive optical network (PON) connecting a central equipment and a plurality of terminal equipments in an uplink direction;

FIG. 3 shows an example of an access network of an embodiment of the invention in the form of a passive optical network (PON) connecting a central equipment and a plurality of terminal equipments in the downlink direction;

FIG. 4 shows an example of an access network of an embodiment of the invention in the form of a passive optical network (PON) connecting a central equipment and a plurality of terminal equipments in the uplink direction;

FIG. 5 shows an example of a device of an embodiment of the invention for processing a composite optical signal in the electrical domain; and

FIG. 6 shows an example of a device of an embodiment of the invention for processing a composite optical signal in the optical domain.

DETAILED DESCRIPTION OF ILLUSTRATIVE EMBODIMENTS

The general principle of an embodiment of the invention is based on processing a composite electrical signal formed of a sequence of time sectors obtained by time-division multiplexing a plurality of optical signals transmitted on a plurality of transmission channels of a shared optical access network using a method taking account of a schedule for transmitting the optical signals in the optical access network in order to apply an appropriate correction to each time sector of the composite optical signal.

Penalties are inevitably incurred when an optical signal is transmitted over an optical access network. Such penalties are the result of physical interference of the mode, polarization or chromatic dispersion type or of non-linear effects. They are a function of the propagation distance, bit rate, power injected, and environmental stresses on the optical fiber. If the range of an optical access network is increased beyond 20 km, the penalties increase. Correction of the composite optical signal is then necessary to reduce these penalties and to guarantee that the optical signal received by the receiver is of good quality.

The following description relates to a shared optical access network connecting a central equipment and N terminal equipments, where N is an integer greater than 1. Embodiments are described below with reference to the appended drawings. For simplicity, three terminal equipments are considered (N=3). However, the invention is not limited to this restricted number of terminal equipments and relates to any optical access network architecture including a plurality of terminal equipments.

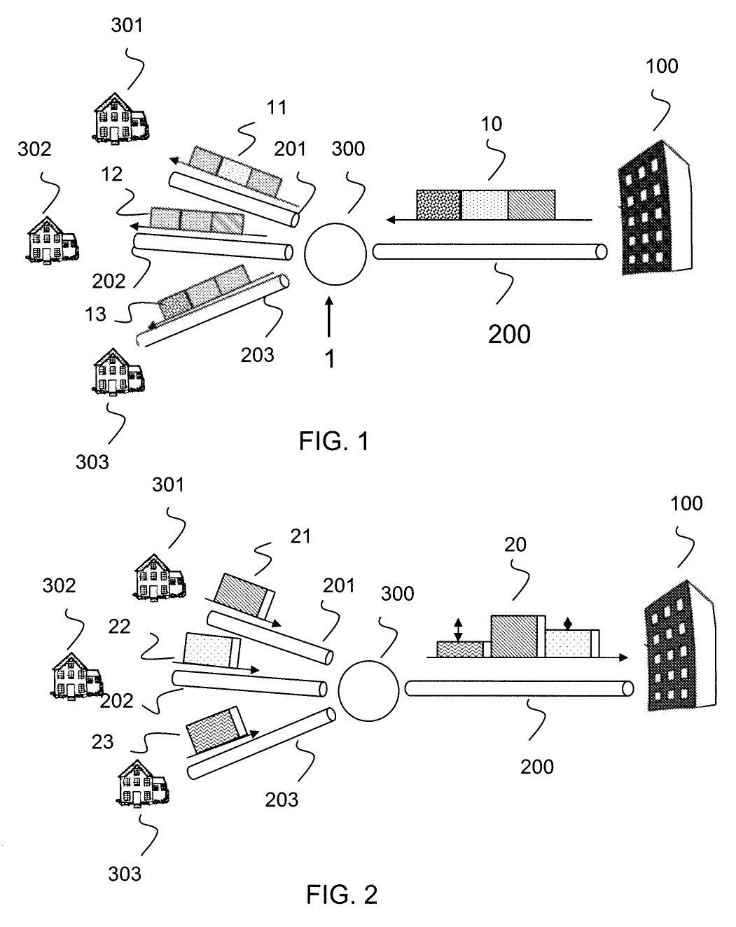

FIG. 1 shows an optical signal 10 transmitted in the downlink direction in a prior art shared optical access network. The access network 1 includes a central equipment 100, also known as an optical line terminal (OLT), connected to a 1-to-3 coupler 300 by a transmission channel 200. The coupler 300 is a passive device and is itself connected to three terminal equipments 301 to 303 by respective transmission channels 201 to 203. Such terminal equipments are also designated by the optical modules that they contain, also knows as optical network units (ONU).

The coupler 300 receives from the central equipment a downlink composite optical signal 10 having its frame made up firstly of management sectors common to all users, and transporting frame management and configuration information, and secondly N contiguous time-division multiplex (TDM) data time sectors 11 to 13 for the end terminal equipments 301 to 303. The usable bit rate offered to users therefore corresponds to a fraction of the line bit rate. In the conventional way, data is transmitted in base band using NRZ (no return to zero) coding.

FIG. 2 shows an optical signal 20 transmitted in the uplink direction in the same prior art shared optical access network 1. The optical signal 20 is a time-division multiplex composite signal the frame of which is made up of N time sectors 21 to 23 sent by the N terminal equipments 301 to 303. To prevent these time sectors overlapping, the central equipment synchronizes and controls the transmission times of the optical modules of the terminal equipments 301 to 303. In particular, the downlink frame from the central equipment 100 locks the synchronization of the clocks of the various users. A reference clock is provided by the central equipment. To generate the clock time for their uplink stream, the terminal equipments lock onto this clock, which they recover from the bit times of the downlink stream.

However, this synchronization cannot prevent uncertainty as to the position in time of the sectors. This uncertainty imposes the use of a minimum guard time between two consecutive sectors. Accordingly, for each time sector of the composite optical signal, it is therefore necessary for the central equipment to relock the phase of the data of the time sectors, which entails comparing the phase time of the uplink streams to a reference clock.

The central equipment 100 also includes a photodetector module for converting the received composite optical signal 20 into an electrical signal. Such a module must adapt to the varying optical budget and optical transmission power of each of the terminal equipments 301 to 303, in particular in terms of electrical gain.

The following processes are necessary for correct detection of the uplink composite optical signal received by the central equipment: the activation/deactivation times (Ton/Toff) of the laser of the terminal equipment, l, recovering the optical power level, recovering the clock time and the beginning of delimitation of the burst. The exact subdivision of the time of the physical layer for all these functions is determined partly by constraint equations and partly by implementation choices.

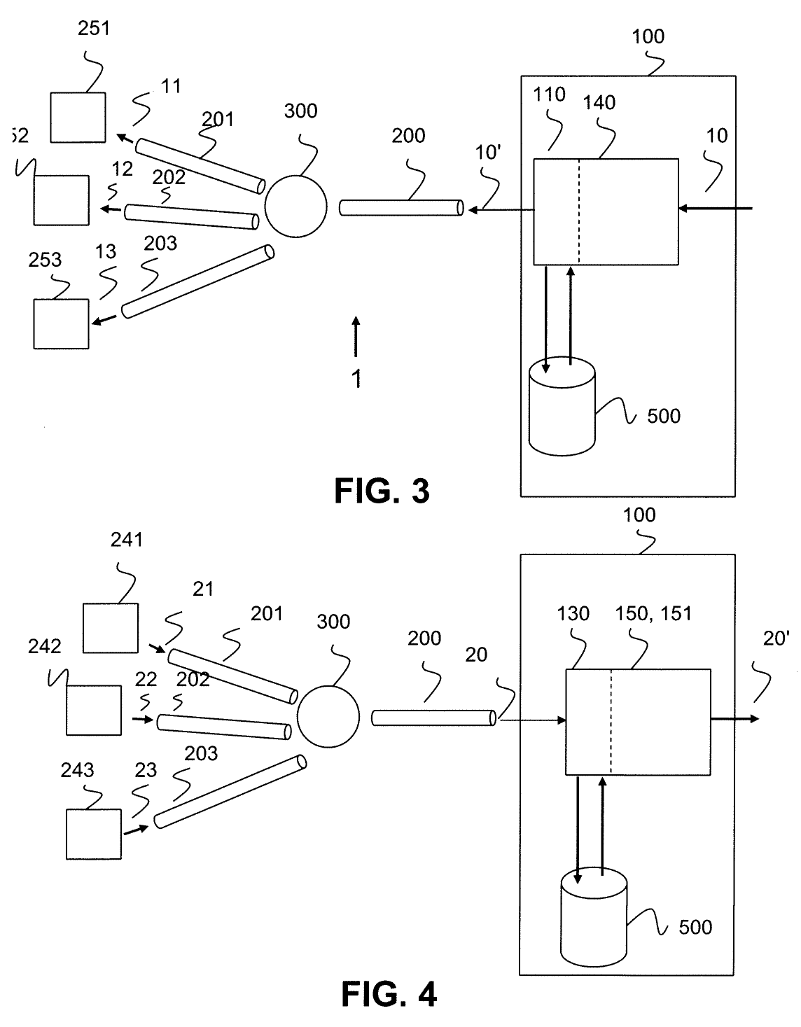

One embodiment of a shared optical access network of the invention is described below by way of example and with reference to FIG. 3. This example relates to downlink transmission of optical signals, i.e. in the direction from the central equipment 100 to the terminal equipments 301 to 303. The central equipment 100 includes a transceiver 110 for transmitting a composite optical signal formed of a sequence of time sectors obtained by time-division multiplexing a plurality of optical signals going to the receivers 251 to 253 respectively belonging to the terminal equipments 301 to 303 (for clarity, only the receivers of the terminal equipments are shown). The transceiver 110 of an embodiment of the invention includes a device 140 that processes the composite optical signal 10 and then transmits a downlink processed composite optical signal 10′ to the receivers of the terminal equipments 251 to 253.

The processing device 140 includes means for adaptively correcting the composite optical signal 10 that adapt the processing parameters to suit each time sector of said signal as a function of a schedule for transmitting said plurality of optical signals in said access network.

A transmission schedule is a table associating with a time sector the composite optical signal to which it belongs and the transmission channel that it has used or will use. The expression “transmission channel” is used here to refer generically to the path formed of a transmission channel or a succession of transmission channels that the time sector takes from its source to its destination.

In this example, the path to be associated with a time sector of the optical signal 11 is made up of the transmission channel 200 and the transmission channel 201. The transmission schedule is stored in a database 500 of the shared optical access network 1, for example.

The processing device 140 preprocesses the composite optical signal 10 on the basis of its a priori knowledge of the transmission channels 200 and 201. Clearly this preprocessing is adaptive in that it varies according to the time sector concerned as a function of performance characteristics of the transmission channel 201, for example its distance, optical losses or chromatic dispersion. The device 140 of an embodiment of the invention implementing this preprocessing is generally able to take account of any effect generating a transmission penalty.

The processing device 140 of an embodiment of the invention is preferably located in the central equipment. One advantage of this is that only one device 140 is needed to preprocess the composite optical signal sent to the plurality of terminal equipments, which optimizes resources and limits the operating costs of the shared optical access network.

A shared optical access network conforming to another embodiment of the invention is described below with reference to FIG. 4. This example relates to transmitting uplink optical signals, i.e. in the direction from the terminal equipments 301 to 303 to the central equipment 100. The central equipment 100 includes a transceiver 130 able to receive a composite optical signal 20 formed of a sequence of time sectors obtained by time-division multiplexing a plurality of optical signals from transmitters 241 to 243 respectively belonging to the terminal equipments 301 to 303 (not shown in this figure). The transceiver 130 of an embodiment of the invention includes a device 150, 151 for processing the composite optical signal 20 to produce a processed composite optical signal 20′.

The processing device 150, 151 includes means for adaptively correcting the received composite optical signal 20 able to adapt the processing parameters to suit each time sector of said signal as a function of a schedule for transmitting said plurality of optical signals in said access network.

The processing device 150, 160 post-processes the composite optical signal 20 on the basis of its a priori knowledge of the transmission channels 200 and 201 to 203. The post-processing is adaptive in that it varies according to the time sector concerned as a function of the characteristics of the transmission channel 201 to 203 used. Like the device 140, the device 150, 151 of an embodiment of the invention can take into account any effect generating a transmission penalty.

According to an embodiment of the invention, the processing device 150, 151 is preferably located in the central equipment. An advantage of this is that only one post-processing device 130 is needed to process the received composite optical signal coming from the terminal equipments. This optimizes resources and limits the operating costs of the optical access network.

Note, however, that according to another aspect of the invention, the access network can include, for processing downlink signals, post-processing devices located in each of the terminal equipments 301 to 303. Such devices modify the adaptive pre-processing performed in the central equipment 100.

Similarly, for the uplink direction, the shared optical access network 1 of an embodiment of the invention can include pre-processing devices located in each of the transmitters 241 to 243 of the terminal equipments 301 to 303 in order to improve the quality of the composite optical signal 10 received by the post-processing device 130 in the central equipment 100.

According to an embodiment of the invention, the processing parameters are computed from a set of representative performance parameters of the transmission channel associated with the time sector concerned.

According to one aspect of an embodiment of the invention, a set of mean values of the processing parameter is computed for the plurality of optical signals to be processed.

According to another aspect of an embodiment of the invention, specific values of the processing parameters are computed for each of the optical signals of the optical signals 11 to 13, 21 to 23 concerned.

According to a further aspect of an embodiment of the invention, the values of the representative performance parameters of said transmission channels are computed by a training process. Such training is generally carried out on initializing transmission over the access network. It is preferably repeated regularly to prevent drift of the adaptive processing device.

According to an embodiment of the invention, the processing performed by the processing device 140, 150, 151 can take place in the optical domain or in the electrical domain.

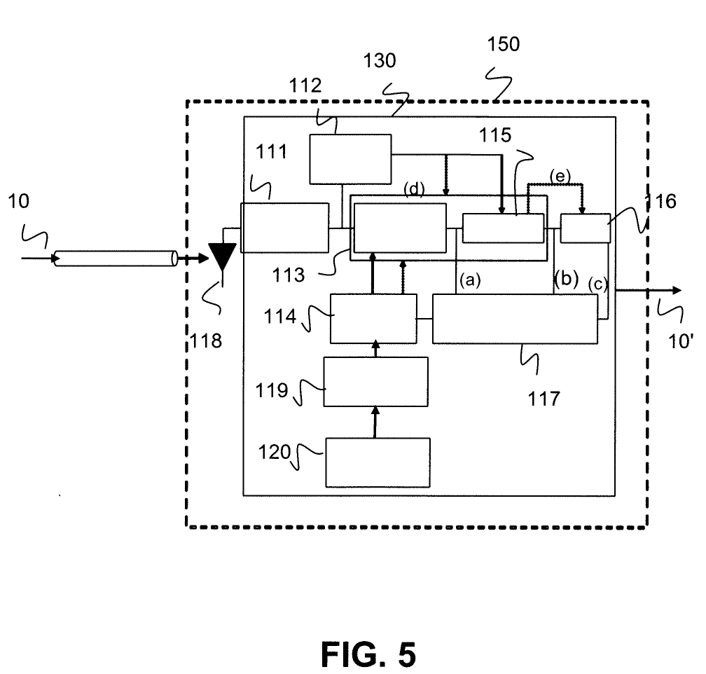

An embodiment of a receiver 150 located in the central equipment and including a processing device of an embodiment of the invention adapted to function in the electrical domain is described below with reference to FIG. 5.

The receiver 130 includes a processing device 150 for processing the composite optical signals formed from uplink optical signals 11 to 13 received by the central equipment 100 from the terminal equipments 301 to 303.

Such a receiver 130 includes a photodiode 118 for converting the composite optical signal into an electrical signal. The electrical signal obtained is then processed by the processing device 150, which includes a low-pass filter module 111 for filtering the electrical signal. The filtered electrical signal is then resynchronized using means 112 for recovering a clock signal. The resynchronized electrical signal is processed by an electronic module 113 for processing the signal to reshape the resynchronized electrical signal in order to facilitate decision making. The electrical signal processed in this way is fed to the input of a decision module 115 able to decide on a 0 or a 1 on the basis of the input electrical signal. The signal decided on is then fed to a correction module 116 that uses forward error coding (FEC). The electronic processing module 113 relies on adaptive processing parameters that are defined on the basis of a set of representative performance parameters of the transmission channel or channels used by the signal to be processed. Such parameters include, for example, the impulse response of the channel, estimates of the error rate for each sequence, and estimates of the eye aperture.

A time sector is considered that comes from an i^{th} optical signal of the N optical signals coming from the terminal equipments forming the composite optical signal received by the central equipment, where N>0 and i is an integer greater than 0 and less than N. According to an embodiment of the invention, the processing parameters to be applied by the electronic processing module 113 to a time sector of the composite optical signal 10 are determined from a transmission schedule 120. Such a schedule can take the form of a table associating with a time sector all the representative performance parameters of the transmission channel or channels used by the signal from which it originates. A processing parameter determination module 119 computes the processing parameters appropriate to the time sector concerned from this set of transmission parameters supplied by the schedule 120.

The processing device 150 can advantageously further include a feedback loop including a measuring module 117 and a tracking module 114. The measuring module 117 measures a performance indicator of the processed signal obtained at the output (a) of the electronic processing module 113, at the output (b) of the decision-making module 115 or at the output (c) of the error correcting code corrector module 116. The performance indicator is transmitted to the tracking module 114, which modifies the processing parameters used by the electronic processing module 113. The resynchronized electrical signal is electronically processed again using the new processing parameter values. The feedback loop is repeated until the corrected signal decided on converges to the best value. The processing parameter values finally obtained are applied to the next time sector of the i^{th} optical signal.

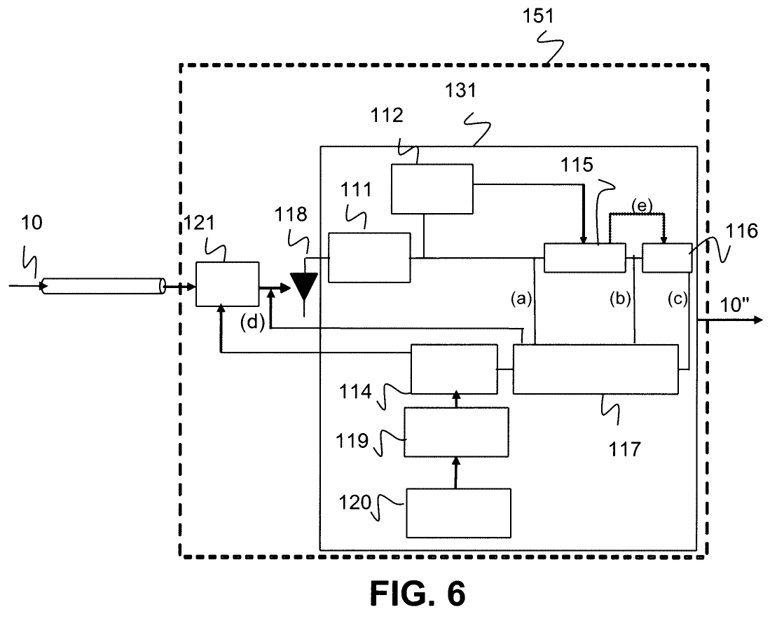

One embodiment of a receiver 131 located in the central equipment 100 and including a processing device 151 of an embodiment of the invention functioning partly in the optical domain and partly in the electrical domain is described below with reference to FIG. 6.

The processing device 151 processes an uplink composite optical signal 10 received by the central equipment 100 from the transmitters 241 to 243. It supplies a processed composite optical signal 10″. To this end, said processing device includes an optical processing module 121 for reshaping the composite optical signal received by the central equipment 100 and an electrical processing module 131. Such a module can be implemented by means of an optical trellis filter or a tunable chromatic dispersion compensator, for example. The reshaped optical signal is then converted by the photodiode 118 into an electrical signal. The electrical signal obtained is then processed by the electrical processing module 131, which includes a low-pass filter module 111 for filtering the electrical signal, means for recovering a clock signal 112 in order to resynchronize the filtered electrical signal, and a decision module 115 for deciding on a 0 or a 1 on the basis of the resynchronized filtered electrical signal. The signal decided on can then be sent to a correction module 116 using forward error coding (FEC).

The optical processing module 121 relies on adaptive processing parameters that are defined on the basis of a set of representative performance parameters of the transmission channel. Such a set includes the impulse response of the channel, estimates of the error rates for each sequence or estimates of the eye aperture, for example. The particular object of the adaptive processing applied to the time sector of the received composite optical signal is to invert the impulse response of the transmission channel.

By associating an optical signal and a transmission channel with a time sector, the transmission schedule 120 accesses all the transmission parameters corresponding to the time sector to be processed.

The module 119 for determining processing parameters then computes the processing parameters appropriate to the time sector concerned from this set of transmission parameters supplied by the schedule 120. The processing device can advantageously include a feedback loop including a measuring module 117 and a tracking module 114. The measuring module 117 measures a performance indicator of the processed signal obtained at the output (a) of the filtering module 111, at the output (b) of the decision-making module 115 or at the output (c) of the correction module 116 using forward error correction. The performance indicator is sent to the tracking module 114, which modifies the processing parameters used by the electronic processing module 113 and sends them to the optical processing module 121. The time sector concerned of the received optical signal is optically processed again using the new processing parameter values. The feedback loop is repeated until the corrected signal decided on converges to the best value.

This embodiment employing a part optical, part electrical processing device 151 can also be used in the downlink direction. The composite optical signal is then advantageously pre-processed in the transmitter located in the central equipment 100. The pre-processing device similarly has the object of inverting in advance the transmission channel that is to transport the composite optical signal.

In the same way as for electrical processing, the feedback loop computes the best parameter values to be applied to the next time sector of the same optical signal as the current time sector. However, the feedback loop differs from that used in the uplink direction. It is based on measuring the quality of the optical signals received by the terminal equipment. Such measurements must therefore be fed back to the central equipment, for example in the headers of TDM packets.

The examples of FIGS. 5 and 6 relate to the uplink direction. However, an adaptive processing device of an embodiment of the invention can be used in the downlink direction with a similar architecture, subject to different adjustments. In this respect, it must be noted that, for reasons of efficiency, adaptive processing according to an embodiment of the invention for the downlink direction is preferably effected in the optical domain. Conversion by the photo-electric diode 118 is an irreversible operation. Consequently, electrical-optical conversion would degrade the processed composite optical signal.

In one particular embodiment of the invention, the steps of the method for processing a composite optical signal are determined by the instructions of a computer program incorporated into a data processing device such as the device 150, 151. The program includes program instructions which execute the steps of the method when said program is loaded into and executed in a device whose operation is then controlled by the execution of the program.

Consequently, an embodiment of the invention applies equally to a computer program, notably a computer program on or in an information storage medium, adapted to implement an embodiment of the invention. This program can use any programming language and take the form of source code, object code or a code intermediate between source code and object code, such as a partially-compiled form, or any other desirable form for implementing the method of an embodiment of the invention.

One particular embodiment of the disclosure corrects the transmitted time-division multiplex optical signal in order to correct the penalties introduced in its transmission on a 1-to-N connection.

To be more precise, a particular embodiment provides a solution for correcting the transmitted time-division multiplex optical signal that adapts to transmission parameters, which are liable to vary, of the successive time sectors forming the composite optical signal.

Although the present disclosure has been described with reference to one or more examples, workers skilled in the art will recognize that changes may be made in form and detail without departing from the scope of the disclosure and/or the appended claims.

1-15. (canceled)

16. A method of processing a composite optical signal formed of a sequence of time sectors obtained by time-division multiplexing a plurality of optical signals transmitted on a plurality of transmission channels of a shared optical access network, said method including the following steps:
taking account of a schedule for transmission of said plurality of optical signals in said access network, said schedule associating with a time sector an optical signal of the sequence and a transmission channel of said plurality of transmission channels used by said optical signal;
recovering a set of representative performance parameters of said transmission channel associated with said time sector;
computing a set of correction parameter values from said set of representative performance parameters of said channel; and
adaptively correcting the time sector using the set of correction parameters.

17. The method of processing according to claim 16, wherein said adaptive correction step uses a set of average values of processing parameters computed for the plurality of optical signals.

18. The method of processing according to claim 16, wherein the set of processing parameter values computed is specific to an optical signal.

19. The method of processing according to claim 16, wherein the values of said representative performance parameters of said plurality of transmission channels are computed by a training process.

20. The method of processing according to claim 19 wherein said training process is performed on initialization of the plurality of transmission channels.

21. The method of processing according to claim 19 wherein said training process is repeated during functioning of the transmission channel.

22. The method of processing according to claim 16, wherein the adaptive correction step corrects the composite optical signal in the optical domain.

23. The method of processing according to claim 16, wherein the method includes, before the adaptive correction step, a step of converting the composite optical signal into a composite electrical signal and the adaptive correction step corrects the composite electrical signal in the electrical domain.

24. A device for processing a composite optical signal formed of a sequence of time sectors obtained by time-division multiplexing a plurality of optical signals transmitted on a plurality of transmission channels of a shared optical access network, said device comprising:
means for taking account of a schedule for transmission of said plurality of optical signals in said access network, said schedule associating with a time sector an optical signal of the sequence and a transmission channel of said plurality of transmission channels used by said optical signal;
means for recovering a set of representative performance parameters of said transmission channel associated with said time sector;
computing a set of correction parameter values from said set of representative performance parameters of said channel; and
means for adaptively correcting the time sector using the set of correction parameters.

25. A central equipment of a optical access network shared between a plurality of terminal equipments able to transmit a first composite optical signal formed of a sequence of time sectors obtained by time-division multiplexing a first plurality of optical signals going to said plurality of terminal equipments, wherein the central equipment comprises a first device for processing the first composite signal including:
means for taking account of a schedule for transmission of said plurality of optical signals in said access network, said schedule associating with a time sector an optical signal of the sequence and a transmission channel of said plurality of transmission channels used by said optical signal;
means for recovering a set of representative performance parameters of said transmission channel associated with said time sector;
computing a set of correction parameter values from said set of representative performance parameters of said channel; and
means for adaptively correcting the time sector using the set of correction parameters.

26. The central equipment of a shared optical access network according to claim 25, able to receive a second composite signal formed of a sequence of time sectors obtained by time-division multiplexing a second plurality of optical signals coming from said plurality of terminal equipments, wherein the central equipment comprises a second device for processing the second composite signal including:
means for taking account of a schedule for transmission of said plurality of optical signals in said access network, said schedule associating with a time sector an optical signal and a communications channel used by said optical signal;
means for recovering a set of representative performance parameters of said transmission channel associated with said time sector;
computing a set of correction parameter values from said set of representative performance parameters of said channel; and
means for adaptively correcting the time sector using the set of correction parameters.

27. An optical access network shared by a plurality of terminal equipments connected to a central equipment by a plurality of transmission channels, said central equipment being adapted to transmit a first composite signal formed of a sequence of time sectors obtained by time-division multiplexing a first plurality of optical signals whose destination is said plurality of terminal equipments, wherein said central equipment comprises a first device for correcting said first composite signal including:
means for taking account of a schedule for transmission of said plurality of optical signals in said access network, said schedule associating with a time sector an optical signal of the sequence and a transmission channel of said plurality of transmission channels used by said optical signal;
means for recovering a set of representative performance parameters of said transmission channel associated with said time sector;
computing a set of correction parameter values from said set of representative performance parameters of said channel; and
means for adaptively correcting the time sector using the set of correction parameters.

28. The shared optical access network according to claim 27, wherein said central equipment is able to receive a second composite optical signal formed of a sequence of time sectors obtained by time-division multiplexing a second plurality of optical signals coming from said plurality of terminal equipments, said central equipment comprising a second device for correcting said second composite signal, including:
means for taking account of a schedule for transmission of said plurality of optical signals in said access network, said schedule associating with a time sector an optical signal of the sequence and a transmission channel of said plurality of transmission channels used by said optical signal;
means for recovering a set of representative performance parameters of said transmission channel associated with said time sector;
computing a set of correction parameter values from said set of representative performance parameters of said channel; and
means for adaptively correcting the time sector using the set of correction parameters.

29. A computer program product on a computer-readable medium, wherein the product includes program code instructions for performing, when executed on a computer, a method of processing a composite optical signal formed of a sequence of time sectors obtained by time-division multiplexing a plurality of optical signals transmitted on a plurality of transmission channels of a shared optical access network, said method comprising:
taking account of a schedule for transmission of said plurality of optical signals in said access network, said schedule associating with a time sector an optical signal of the sequence and a transmission channel of said plurality of transmission channels used by said optical signal;
recovering a set of representative performance parameters of said transmission channel associated with said time sector;
computing a set of correction parameter values from said set of representative performance parameters of said channel; and
adaptively correcting the time sector using the set of correction parameters.
